(19) United States
(12) Patent Application Publication
(10) Pub. No.: US 2006/0247848 A1
(43) Pub. Date: Nov. 2, 2006

(54) DRIVING ROUTE PLANNING SYSTEM AND METHOD

(75) Inventor: Po-Wei Cheng, Taoyuan (TW)

Correspondence Address: THE LAW OFFICES OF MIKIO ISHIMARU, 333 W. EL CAMINO REAL, SUITE 330, SUNNYVALE, CA, 94087, US

(73) Assignee: Mitac International Corporation, Taoyuan (TW)

(21) Appl. No.: 11/381,124

(22) Filed: May 1, 2006

(30) Foreign Application Priority Data
May 2, 2005 (TW) 094114089

(51) Int. Cl. G08G 1/00

(52) U.S. Cl. 701/200; 701/117

(57) ABSTRACT

A driving route planning system includes a data processing center for collecting real-time traffic information and storing the collected real-time traffic information in a database. The data processing center includes a transmission interface for emitting the stored real-time traffic information receiving requests. The system further includes an electronic device including an electronic route guiding program for planning driving routes, a communication interface for connecting to the data processing center to receive the traffic information transmitted from the data processing center and emit real-time traffic information updating request to the data processing center, and a storage unit for receiving the real-time traffic information received by the communication interface. The electronic route guiding program, when planning a driving route, compares an overlap situation between the real-time traffic information stored in the storage unit and the planned driving route, and takes the overlap situation as a basis to re-plan the driving route.

### BACKGROUND OF THE INVENTION

1. Field of the Invention

This invention relates to navigation techniques, and more particularly, to a driving route planning system and method applicable to an electronic device having an electronic navigation function.

2. Description of Related Art

Global positioning system (GPS) is a 24-hour passive wireless positioning system used for covering the whole earth. GPS is developed, controlled and managed by US Defense Department, for the use of a varieties of mobile entities, such as airplanes, aircrafts, battle ships, commercial ships, mobile cars and pedestrians, all of which have a GPS receiver for providing accurate information about position, velocity and time.

In general, a modern car navigation equipment has a road positioning function and a road navigating function. The road positioning function makes the use of a global satellite positioning system and an inertial navigation system (including a location detector and a velocity detector) to calculate the location coordinate of a car having the car navigation equipment, and compare the location coordinate with road information stored in a road database, so as to calculate the road on which the car is driving and where the car is accurately.

The road navigation function allows a user to set a position of departure and a destination, and adopts a preferred route selection algorithm to determine a “recommended driving route”, which is the best (or the shortest) route for the user to drive the car from the position of departure to the destination. The road navigation function further records a driving route on which the car has driven and suggests the user whether or not to make a turn when the car reaches a crossroad in accordance with the “recommended driving route” and the road positioning function. Moreover, the road navigation function keeps to monitor whether the car is on the “recommended driving route” or not, and determines another “recommended driving route” to the destination from a current position where the car is staying currently in accordance with the current position and a current driving direction in which the car is heading if the car is monitored not on the “recommended driving route”.

How fast can the user arrive to the destination if driving the car along the “recommended driving route” is influenced by varieties factors, such as a road congestion factor, a traffic control/road construction factor, and a road interruption factor.

The road congestion factor can be categorized into an expected part and an unexpected part. For example, the expected part means that a road congestion happens in a certain area such as a highway during a certain period such as a long weekend, and the unexpected part means another road congestion resulted from a car accident.

The traffic control/road construction factor is usually followed with a predetermined plan, so a road under the predetermined plan is temporarily blocked or has fewer open lanes within a predetermined period.

The road interruption factor means that a road is interrupted due to an act of Providence such as an earthquake, which may interrupt a road completely.

The above three factors greatly reduce the velocity at which the user is allowed to drive the car, or even traps the user from driving the car to anywhere. However, the above-mentioned car navigation equipment, when determining the “recommended driving route”, takes only a shortest route between the position of departure and the destination into consideration, without further considering whether any road in the “recommended driving route” is blocked or not. In result, the user still has to spend much time to arrive the destination, even though the car navigation equipment has determined a “shortest” “recommended driving route”, which includes the blocked road.

Therefore, how to develop a driving route planning system capable of acquiring traffic information timely and determining and adjusting a recommended driving route in accordance the traffic information has becoming one of the most important errands in the art.

### SUMMARY OF THE INVENTION

In views of the above-mentioned problems of the prior art, it is a primary objective of the present invention to provide a driving route planning system and method for adjusting a driving route at any time when receiving real-time traffic information, to reduce time to driving a car. It is another objective of the present invention to provide a driving route planning system and method for a user to avoid congested roads and improve a traffic congested situation by adjusting a driving route.

To achieve the above-mentioned and other objectives, a driving route planning system and method is provided according to the present invention. The driving route planning system includes a data processing center for collecting real-time traffic information and storing the collected real-time traffic information in a database. The data processing center includes a transmission interface for emitting the stored real-time traffic information receiving requests. The driving route planning system further includes an electronic device including an electronic route guiding program for planning driving routes, a communication interface for connecting to the data processing center to receive the traffic information transmitted from the data processing center and emit real-time traffic information updating request to the data processing center, and a storage unit for receiving the real-time traffic information received by the communication interface. The electronic route guiding program, when planning a driving route, compares an overlap situation between the real-time traffic information stored in the storage unit and the planned driving route, and takes the overlap situation as a basis to re-plan the driving route.

According to one embodiment, that the transmission interface of the data processing center receives the request means that the communication interface of the electronic device emits traffic information updating request actively, enabling the data processing center to transmit the traffic information stored in the database via the transmission interface to the electronic device. According to another embodiment, that the transmission interface of the data processing center emits the traffic information stored in the database means that the data processing center emits real-time traffic information actively via the transmission interface to the electronic device.

The driving route planning method is applied to an electronic device having an electronic route guiding program, for enabling the electronic device to have a driving route planning function. The method includes establishing a data processing center for collecting real-time traffic information and storing the collected real-time traffic information in a database; enabling the electronic device to execute the electronic route guiding program to plan a driving route; and enabling the electronic device to acquire the real-time traffic information stored in the database of the data processing center and compare an overlap situation between the acquired real-time traffic information and a planned driving route and take the overlap situation as a basis to re-plan the traffic route.

According to one embodiment, before acquiring the real-time traffic information stored in the database of the data processing center, the electronic device is enabled to emit traffic information updating requests to enable the data processing center to transmit the traffic information stored in the database to the electronic device. According to another embodiment, that the transmission interface of the data processing center emits the traffic information stored in the database means that the data processing center emits real-time traffic information actively via the transmission interface to the electronic device.

The present invention makes the use of a data processing center to collect real-time traffic information. Therefore, an electronic navigation device can acquire corresponding traffic information happening at any time, and adjust a driving route accordingly, and a user can avoid congested route and saves driving time.

### BRIEF DESCRIPTION OF DRAWINGS

The invention can be more fully understood by reading the following detailed description of the preferred embodiments, with reference made to the accompanying drawings, wherein:

FIG. 1 is a functional block diagram of a driving route planning system according to the present invention;

FIG. 2 is a flow chart of a real-time traffic information collecting process of a driving route planning method according to the present invention; and

FIG. 3 is a flow chart of a driving route planning process of the driving route planning method according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

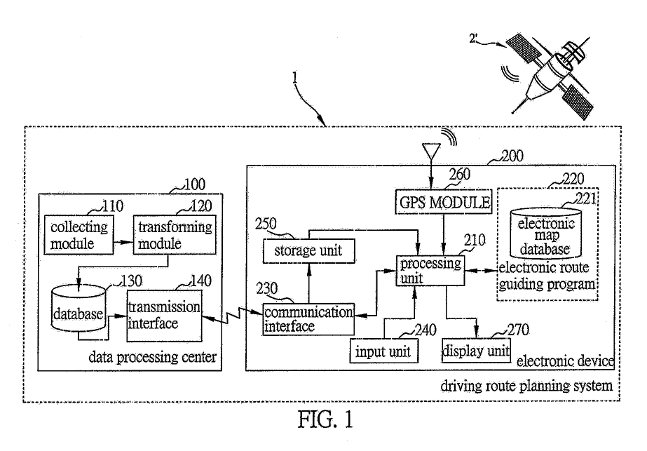

FIG. 1 is a functional block diagram of a driving route planning system 1 of the preferred embodiment according to the present invention. The driving route planning system 1 comprises a data processing center 100 and at least an electronic device 200. Only one electronic device 200 is introduced herewith as an example to demonstrate the driving route planning system 1. Another driving route planning system of the present invention can comprise more than one electronic device 200. According to the preferred embodiment, the electronic device 200 is a personal digital assistant (PDA) having a global positioning system (GPS) function, a cellular phone, a smart cellular phone, a GPS system for cars, or a notebook computer. The data processing center 100 is used for collecting and storing real-time traffic information. According to the preferred embodiment, the data processing center 100 is a server. The data processing center 100 comprises a collecting module 110, a transforming module 120, a database 130 and a transmission interface 140.

The collecting module 110 is used for collecting the real-time traffic information. According to the preferred embodiment, the collecting module 110 collects the real-time traffic information by the transmittance of data and traffic reports by drivers. According to the preferred embodiment, the collected real-time traffic information mean abrupt or temporarily adjusted real-time traffic information.

The transforming module 120 is used for transforming the real-time traffic information collected by the collecting module 110 into transformed data having certain formats recognizable by the driving route planning system 1, and for storing the transformed data into the database 130. According to the preferred embodiment, the real-time traffic information stored in the database 130 comprise longitude and latitude data where traffic accidents happen and traffic descriptions corresponding to the traffic accidents. The traffic descriptions comprise varieties of specific descriptions, such as descriptions of traffic congestion and traffic control, which are stored in the database 130 in the form of different codes. For example, a code “1” represents “traffic congestion”, and another code “2” represents “traffic control”.

The transmission interface 140 is used for transmitting the real-time traffic information stored in the database 130 to the electronic device 200.

The electronic device 200 comprises at least a processing unit 210, an electronic route guiding program 220, a communication interface 230, an input unit 240, a storage unit 250, a GPS MODULE 260 and a display unit 270. Note that the electronic device 200 further comprises other components, which are omitted herewith for simplicity, and only the components directly relating to the present invention are shown in FIG. 1. The electronic device 200 has a GPS navigation function through the installation of the electronic route guiding program 220 and the GPS MODULE 260. The GPS MODULE 260 can be selectively embedded in or connected externally (wirelessly or in wired manner) to the electronic device 200. The electronic route guiding program 220 is stored in a memory (not shown) of the electronic device 200. By controlling the processing unit 210 to execute the electronic route guiding program 220, the electronic device 200 can provide positioning and driving route planning processes. The GPS MODULE 260 is used for processing received signals emitted from a satellite 2′, and transmitting a positioning result obtained after execution of the positioning process to the processing unit 210. Then the processing unit 210, in accordance with the positioning results, enables the electronic route guiding program 220 to read an electronic map corresponding to the positioning result from an electronic map database 221, and controls the display unit 270 to display the electronic map. Thus, a user of the electronic device 200 knows where he is now. Before the electronic route guiding program 220 actuates a driving route planning function, the user is allowed to input the position of departure and destination through the use of the input unit 240 (a device such as a touch panel, key buttons and a keyboard for the user to input control signals) During an input process, the electronic route guiding program 220 provides a driving route planning input table (not shown), which is controlled by the processing unit 210 and displayed on the display unit 270, for the user to input the control signals easily. After the control signals are input, the electronic route guiding program 220 plans a preferred driving route in accordance with input data input by the user and geographic information stored in the electronic map database 221, and displays the preferred driving route on the display unit 270, for the user's reference. Since GPS's applying to an electronic device, the processing unit's controlling the electronic device, and the electronic route guiding program are prior arts, further descriptions are hereby omitted. Only components related to the present invention are described in the following paragraphs.

The driving route planning function provided by the electronic route guiding program 220 disclosed by the present invention further has a real-time traffic information updating process, which means that the processing unit 210 enables the communication interface 230 to transmit a traffic information updating request to the data processing center 100 in response to the processing unit's 210 determining that the input unit 240 has received an real-time traffic information updating request, to enable the data processing center 100 to know the request and transmit the real-time traffic information stored in the database via the transmission interface 140 to the electronic device 200. After received by the communication interface 230, the received real-time traffic information will be stored in the storage unit 250. Then the processing unit 260 enables the electronic route guiding program 220 to check whether the real-time traffic information is located in the driving route in accordance with the positioning result emitted from the GPS MODULE 260, the real-time traffic information stored in the storage unit 250, the destination input previously and the geographic information stored in the electronic map database 221, so as to plan a preferred driving route and display the preferred driving route on the display unit 270 [symbol] . Therefore, any route related to traffic accidents, traffic congestion or traffic control are all excluded from the planned driving route, and the user can arrive to the destination as early as possible.

Note that an updating mechanism to update real-time traffic information of the electronic device 200 of the driving route planning system 1 of the present invention further comprises, in addition to the electric device's 200 actively receiving real-time traffic information, the data processing center's 100 actively transmitting traffic accidents, traffic congestion and traffic controls via the transmission interface 140 to the electronic device 200 in varieties of forms such as a short message service (SMS) or a broadcast. Moreover, the updating mechanism can adopt Internet, wireless application protocol (WAP), global radio packet service (GPRS), WiFi, cellular digital packet data(CDPD) and unstructured supplementary service data (US SD) as a connection mechanism, depending on communication protocols adopted by the communication interface 230 of the electronic device 200 and the transmission interface 140 of the data processing center 100.

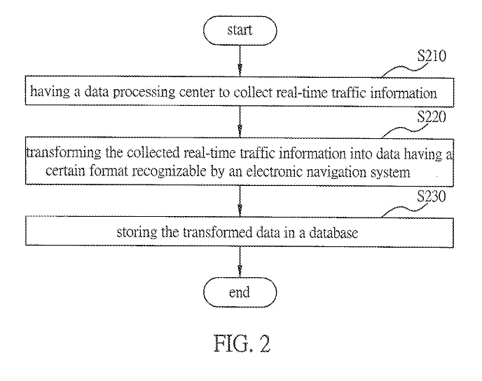

FIG. 2 is a flow chart a real-time traffic information collecting process of a driving route planning method according to the present invention. According to the embodiment, a data processing center 100 is established for collecting real-time traffic information continuously.

The process starts in step S210. In step S210, the process enables the data process center 100 to receive traffic information just happening through the use of upload data by users and reports concerning traffic information made by media such as a radio station. The process proceeds to step S220.

In step S220, the process enables the data processing center 100 to transform the received traffic information to data having a certain format recognizable by the driving route planning system 1. According to the embodiment, a position where a traffic accident happens is transformed into longitude and latitude information, and traffic descriptions corresponding to the traffic accident are transformed into a code. The process proceeds to step S230.

In step S230, the data processing center 100 stores the longitude and latitude information and the code in the database 130.

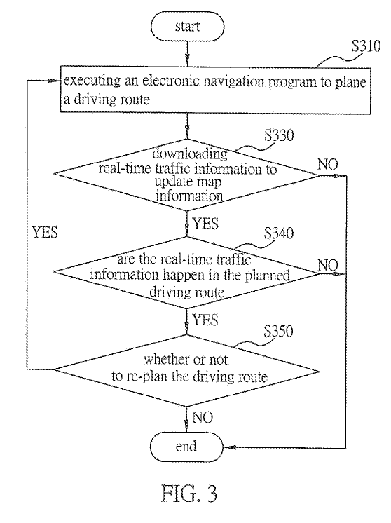

FIG. 3 is a flow chart of a driving route planning process of the driving route planning method according to the present invention. According to the embodiment, the driving route planning method is applied to the electronic device 200, which comprises the electronic route guiding program 220.

The process starts in step S310. In step S310, the process enables the electronic device 200 to execute the electronic route guiding program 220 to plan a driving route. According to the embodiment, when a user actuates a driving route planning function of the electronic device 200, the electronic route guiding program 220, which is embedded in the electronic device 200, takes a reference of corresponding data provided by the electronic map database 221, calculates and plans a driving route, and displays the driving route on the display unit 270, for the user's reference. The process proceeds to step S330.

In step S330, the process enables the display unit 270 of the electronic device 1 to display remind messages “whether or not to update traffic information”, and allows a user to set with the input unit 240. If data input by the user indicate “to update traffic information”, the process enables the communication interface 230 of the electronic device 200 to receive the real-time traffic information collected by the data processing center 100, and store the received traffic information in the storage unit 250. The process then proceeds to step S340; On the contrary, if the data input by the user indicate “not to update traffic information”, the driving route planning process is ended.

In step S340, the process enables the electronic device 200 to compare the received real-time traffic information with a driving route planned in step S310, to determine whether the real-time traffic information is in the planned driving route. According to the embodiment, the electronic device 200 determines whether the real-time traffic information comprise any traffic accident, traffic congestion or traffic control, and whether the location is overlapped with the planned driving route. If the electronic device 200 determines that the location is not overlapped with the planned driving route, the user can drive along the driving route planned previously, or else the process proceeds to step S350.

In step S350, the process enables the display unit 270 of the electronic device 200 to display a remind message for the user to determine whether to re-plan the driving route. If the user chooses to re-plan the driving route, the process returns to step S310, or else the driving route planning process is ended.

Note that a user, when driving a car, is allowed to connect to the data processing center 100 at any time to download real-time traffic information and inspect whether the real-time traffic information relates to remaining routes in the planned driving route, so as to adjust the planned driving route in time. Moreover, the data processing center 100 can transmit real-time traffic information to the electronic device 200 actively.

According to the paragraphs described previously, the present invention makes the use of a data processing center to collect real-time traffic information. Therefore, an electronic navigation device can acquire corresponding traffic information happening at any time, and adjust a driving route accordingly, and a user can avoid congested route and saves driving time.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A driving route planning system comprising:
a data processing center for collecting real-time traffic information and storing the collected real-time traffic information in a database, and data processing center comprising a transmission interface for emitting the stored real-time traffic information stored in the database and receiving requests; and
an electronic device comprising an electronic route guiding program for planning driving routes, a communication interface for connecting to the data processing center to receive the traffic information transmitted from the data processing center and emit real-time traffic information updating request to the data processing center, and a storage unit for receiving the real-time traffic information received by the communication interface, wherein the electronic route guiding program, when planning a driving route, compares an overlap situation between the real-time traffic information stored in the storage unit and the planned driving route, and takes the overlap situation as a basis to re-plan the driving route.

2. The driving route planning system of claim 1, wherein the data processing center is a server.

3. The driving route planning system of claim 1, wherein the data processing center further comprises:
a collecting module for collecting the real-time traffic information; and
a transforming module for transforming the real-time traffic information collected by the collecting module into data having a certain format recognizable by the driving route planning system, and storing the data into the database.

4. The driving route planning system of claim 3, wherein the collected real-time traffic information comprise abrupt or temporarily adjusted real-time traffic information.

5. The driving route planning system of claim 4, wherein the real-time traffic information stored in the database comprise a geographic information of a position where a traffic accident happens and traffic descriptions corresponding to the traffic accident.

6. The driving route planning system of claim 5, wherein the corresponding traffic descriptions comprise one selected from a group consisting of a traffic congestion and a traffic control.

7. The driving route planning system of claim 1, wherein the communication interface of the electronic device and the transmission interface of the data processing center acquire the real-time traffic information stored in the database by a connection mechanism.

8. The driving route planning system of claim 7, wherein the connection mechanism is one selected from a group consisting of Internet, wireless application protocol (WAP), global radio packet service (GPRS), WiFi, cellular digital packet data (CDPD) and unstructured supplementary service data (USSD).

9. The driving route planning system of claim 1, wherein that the transmission interface of the data processing center receives the request means that the communication interface of the electronic device emits traffic information updating request actively, enabling the data processing center to transmit the traffic information stored in the database via the transmission interface to the electronic device.

10. The driving route planning system of claim 1, wherein that the transmission interface of the data processing center emits the traffic information stored in the database means that the data processing center emits real-time traffic information actively via the transmission interface to the electronic device.

11. The driving route planning system of claim 1, wherein the electronic device is one selected from a group consisting of a personal digital assistant (PDA) having a global positioning system (GPS) function, a cellular phone, a smart cellular phone, a GPS system for cars, or a notebook computer.

12. A driving route planning method applied to an electronic device having an electronic route guiding program, for enabling the electronic device to have a driving route planning function, the method comprising:
establishing a data processing center for collecting real-time traffic information and storing the collected real-time traffic information in a database;
enabling the electronic device to execute the electronic route guiding program to plan a driving route; and
enabling the electronic device to acquire the real-time traffic information stored in the database of the data processing center and compare an overlap situation between the acquired real-time traffic information and a planned driving route and take the overlap situation as a basis to re-plan the traffic route.

13. The driving route planning method of claim 12, wherein the data processing center is a server.

14. The driving route planning method of claim 12, wherein the data processing center storing the real-time traffic information in the database further comprises transforming the real-time traffic information collected by the collecting module into data having a certain format recognizable by the driving route planning system.

15. The driving route planning method of claim 12, wherein the collected real-time traffic information comprise abrupt or temporarily adjusted real-time traffic information.

16. The driving route planning method of claim 15, wherein the real-time traffic information stored in the database comprise a geographic information of a position where a traffic accident happens and traffic descriptions corresponding to the traffic accident.

17. The driving route planning method of claim 16, wherein the corresponding traffic descriptions comprise one selected from a group consisting of a traffic congestion and a traffic control.

18. The driving route planning method of claim 12, wherein the electronic device acquires the real-time traffic information stored in the database of the data processing center by a connection mechanism.

19. The driving route planning method of claim 18, wherein the connection mechanism is one selected from a group consisting of Internet, WAP, GPRS, WiFi, CDPD and USSD.

20. The driving route planning method of claim 12, wherein before acquiring the real-time traffic information stored in the database of the data processing center, the electronic device is enabled to emit traffic information updating requests to enable the data processing center to transmit the traffic information stored in the database to the electronic device.

21. The driving route planning method of claim 12, wherein that the transmission interface of the data processing center emits the traffic information stored in the database means that the data processing center emits real-time traffic information actively via the transmission interface to the electronic device.

22. The driving route planning method of claim 12, wherein the electronic device is one selected from a group consisting of a PDA having a GPS function, a cellular phone, a smart cellular phone, a GPS system for cars, or a notebook computer.
